(19) United States
(12) Patent Application Publication
(10) Pub. No.: US 2004/0234076 A1
(43) Pub. Date: Nov. 25, 2004

(54) Device and method for simulation of the presence of one or more sound sources in virtual positions in three-dimensional acoustic space

(76) Inventor: Luigi Agostini, Pisa (IT)

Correspondence Address: Matthew Collins Shepherd & McKay, Suite 306, 100 Thanet Circle, Princeton, NJ, 08540, US

(21) Appl. No.: 10/485,874

(22) PCT Filed: Jul. 9, 2002
(86) PCT No.: PCT/EP02/07622

(30) Foreign Application Priority Data
Aug. 10, 2001 (IT) MI2001A001766

(51) Int. Cl. H04R 5/00; H04R 5/02

(52) U.S. Cl. 381/18; 381/307; 381/63; 381/310

(57) ABSTRACT

Disclosed is a method designed to stimulate the presence of one or more sound sources in virtual positions in three-dimensional space, in the perception of a listener occupying a real physical space, by means of suitable drive loudspeakers whose position is not perceived by the said listener, and a device for the implementation of the said method.

This invention relates to a method designed to simulate the presence of one or more sound sources in virtual positions in three-dimensional acoustic space, in the perception of a listener occupying a real physical space, by means of suitably driven loudspeakers whose position is not perceived by the said listener, and a device for the implementation of the said method.

The said simulation generates the sensation that the listener is in a space with a different shape and size from the real physical space, possibly bounded by one or more walls, in which the listener is actually located.

As the real space must not be perceived, the walls of the said real space (if any) must not produce echoes. The better the sound absorption characteristics of the real walls, the more accurate the simulation will be, because any echoes which cannot be eliminated would reveal the presence of those walls.

Having eliminated the effects of the presence of real walls with the use of sound-absorbing materials, all that reaches the listener will be direct sounds originating from loudspeakers present in the real space; however, the listener must have the impression of perceiving sounds originating from one or more virtual sources located at any point in the virtual space, generally not coinciding with any of the loudspeakers, and perceive both direct sounds originating from the said virtual sources and the sounds reflected off any virtual walls.

The loudspeakers must therefore emit sounds whose vector sum is equivalent to the sound that would reach the said listener if the said sound had been emitted by the virtual sources.

As the sounds are materially produced by a plurality of real loudspeakers located in a different position from the virtual sources to be simulated, the input signals of the said virtual sources will be modified by the device in accordance with the invention, which will calculate the new parameters of the said signals in such a way that when suitably modified signals are sent to the real loudspeakers, a listener present in the real physical space will perceive the sounds emitted by the said real loudspeakers as if they were emitted by the virtual sources they are designed to simulate.

The device in accordance with the invention suitably modifies the said input signals of the said virtual sources, calculating, for each of the said signals, the amount of signal to be sent to each transmission point.

When the effect of any real walls has been eliminated with the use of sound-absorbing materials, the device in accordance with the invention will determine the signals to be sent to the loudspeakers, taking account of the geometrical and acoustic characteristics of the virtual environment and the number and position of the sound transmission points used on each occasion in the real listening environment in relation to the position of (i) the virtual sources to be simulated and (ii) the listener.

When the positions of the virtual sources and the loudspeakers have been determined, a correct simulation can only be effected for a precise position of the listener.

In the usual case of a plurality of listeners, reference will be made to an average listener located in the middle of the group of listeners.

The information about the position of the virtual sources originates from external devices, such as a computer, which informs the device in accordance with the invention of any changes in the position of the virtual sources over time, and supplies once and for all; the characteristics of the listening environment to be simulated.

The device in accordance with the invention will be described below by reference to the annexed figures, wherein:

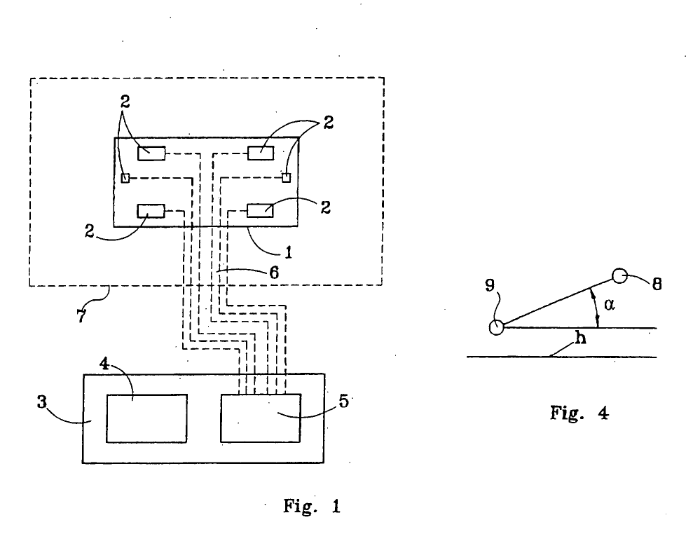

FIG. 1 shows a block diagram of the device in accordance with the invention;

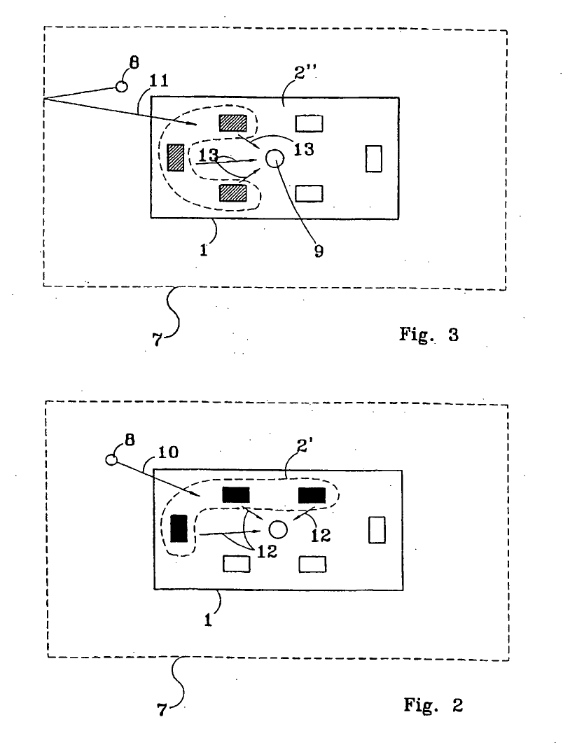

FIG. 2 shows a breakdown of the direct sounds transmitted to the average listener by the virtual source;

FIG. 3 shows the breakdown of the reflected sounds transmitted to the average listener by the virtual source;

FIG. 4 shows the case in which the virtual source is elevated in relation to the average listener.

In the example described by way of example but not of limitation, reference will be made to a typical application, such as a cinema auditorium, in which the real environment is usually bounded by solid walls and contained in a larger virtual environment. The said virtual environment may or may not be bounded by virtual walls. In the said first case, the device in accordance with the invention must simulate the reflection of the sound emitted by the virtual sources off the said virtual walls, while in the second case, as there are no virtual walls, there will obviously be no reflected virtual sounds to simulate.

In the description which follows, reference will be made to a case in which both the said environments are bounded by walls. If the said virtual environment is not so bounded, the device in accordance with the invention will only produce direct sounds which reach the listener from one or more virtual sources.

As shown in FIG. 1, the device in accordance with the invention comprises an anechoic chamber (1) containing a plurality of loudspeakers (2) which, by way of example but not of limitation, are six in number. The signals sent to the said loudspeakers are generated by a device (2) which comprises a generator of original sound (4), namely that emitted by a virtual source, and a computer (5) which processes the signal output by the said generator (4). The said computer (5) is connected by wiring (6) to the said loudspeakers (2).

The said chamber (1) is contained in a larger virtual environment (7).

The device in accordance with the invention is designed to simulate the presence of a sound source (8) (FIG. 2) which is located in the said virtual environment (7), but outside the said chamber (1). In this said case, an average listener (9) must perceive sounds originating from loudspeakers (2) situated inside chamber (1), which are able to generate the impression that the said sounds originate from the said virtual source (8) situated in the virtual environment (7) outside the real chamber (1).

In order for the simulation to be correct, the direct sounds represented by arrow (10) and the sounds reflected off the virtual walls of the virtual environment (7) must reach the said listener (9).

Arrow (11) in FIG. 3 shows the route of a sound which reaches the average listener (9) after being reflected off a virtual wall. The number of the said reflected sounds depends on the number of walls of the virtual environment to be simulated and the number of reflections off the said virtual walls to be considered. For the sake of simplicity, FIG. 3 shows a single reflection (11); however, the sound can reach the listener via numerous routes after reflecting off a number of walls.

All that reaches the average listener (9) will be the direct sounds emitted by loudspeakers (2) located inside chamber (1); the said loudspeakers must therefore emit different sounds from those emitted by virtual source (8) in order to simulate correctly a different spatial location of the said virtual source.

The method in accordance with the invention involves identifying, for direct sound (10) and each reflected sound (11), a subset of loudspeakers which can simulate the said sounds (10) and (11).

A subset (2′) of loudspeakers, each of which will emit a sound (12), is identified for direct sound (10) (FIG. 2). The vector sum of the said sounds (12) emitted by the loudspeakers included in subset (2′) must be equivalent to the direct sound (10) at the point at which average listener (9) is located.

A subset (2″) of loudspeakers, each of which will emit a sound (13), is identified for a reflected sound (11). The vector sum of the said sounds (13) emitted by the loudspeakers included in subset (2″) must be equivalent to the reflected sound (11) at the point at which average listener (9) is located (FIG. 3).

A suitable subset of loudspeakers will obviously be identified for each reflected sound to be simulated.

Each loudspeaker in the said subset will therefore emit a sound such that the vector sum of the sounds emitted by that subset will be equivalent to the reflected sound to be simulated at the point in which average listener (9) is located.

In FIG. 4, ″″ represents the angle of elevation of virtual source (8) in relation to the average listener, situated at height “h” from the ground.

The said elevation of the virtual source in relation to the average listener is simulated by the computer (5) by known techniques which involve the use of a digital filter emulated by the same computer (5).

Computer (5) will modify the signal which would drive virtual source (8) originating from generator (4), and send the signals thus modified to suitable subsets (2′) and (2″) of the said loudspeakers (2) in such a way that they emit (i) sounds (12), the vector sum of which is equivalent to the direct sounds originating from virtual source (8), and (ii) sounds (13), the vector sum of which is equivalent to the reflected sounds originating from the said virtual source (8), respectively.

If there is more than one virtual source, the procedure described below will be repeated for each of the said virtual sources.

The method in accordance with the invention involves reconstructing the behaviour of the direct sound and reflected sounds separately. The procedure is performed in the following stages:

the distance between the position of virtual source (8) and the position of average listener (9) is calculated;

the direction of the line which joins the source to the average listener is calculated;

a subset (2′) of loudspeakers is selected which will be used to transmit sounds (12) in relation to direct sound (10), using the direction of the line that joins the source to the average listener;

the amplitude components relating to the emission of the selected loudspeakers is calculated with known techniques in such a way that the vector sum of sounds (12) emitted by the said selected loudspeakers is equivalent to direct sound (10) emitted by virtual source (8);

the angle of elevation of the source in relation to the average listener is calculated by known techniques, and the values of a digital filter, emulated by computer (5), which is designed to generate the impression of elevation of direct sound (10), are established.

The route of the sounds reflected off the virtual environment is then represented in the following stages:

a pre-set number of reflection routes between the virtual source and the average listener is calculated by a known geometrical process;

the distance travelled by reflected sound (11) is calculated for each of the said routes;

a subset (2″) of loudspeakers, which will be used to output sounds (13) relating to each reflected sound (11), is selected by known techniques, using the direction of the line which joins the average listener to the point on the virtual wall at which the reflection takes place;

the delay with which each reflected sound (1) reaches the average listener compared with direct sound (10) is calculated by known techniques;

the amplitude components relating to the emission of the selected loudspeakers is calculated by known techniques in such a way that the vector sum of sounds (13) emitted by the said selected loudspeakers is equivalent to reflected sound (11) emitted by virtual source (8);

the angle of elevation identified by the direction of the sound reflected towards to the average listener is calculated by known techniques, and the values of a digital filter, emulated by computer (5), which is designed to generate the impression of elevation of reflected sound (11), are established.

The procedure described is repeated for each virtual source to be simulated, and for each reflected sound from each virtual source which it is decided to simulate.

The signals thus processed, which will be sent simultaneously to all the loudspeakers concerned, represent the sum of all the sounds deriving from application of the procedure described above so as to generate the impression in the average listener of being immersed in the virtual environment simulated.

1) Method for simulating the presence of one or more sound sources in virtual positions in acoustic space using a system comprising a plurality of loudspeakers located in an environment in which the listener is situated, and means designed to drive the said loudspeakers independently of one another, characterised in that the behaviour of the direct sound and reflected sounds is reconstructed separately in a virtual environment which lies outside the area in which the listener is situated, wherein:
the distance between the position of the virtual source and the listener's position is calculated;
the direction of the line which joins the source to the listener is calculated;
a subset of loudspeakers is selected which will be used to transmit the direct sound and a set of reflected sounds using the direction of a line that joins the listener to the sound source or the area of the virtual wall at which the reflection takes place;
the amplitude components relating to the emissions of the selected loudspeakers are calculated in such a way that the vector sum of the sounds emitted by the said loudspeakers is equivalent to the direct sound emitted by the virtual source and/or the reflected sound emitted by the virtual source.

2) Method as claimed in claim 1, in which the angle of elevation of the source in relation to the listener is calculated and the values of a digital filter emulated by a computer, designed to generate the impression of elevation of the direct sound, are established.

3) Method as claimed in claim 1, in which the angle of elevation identified by the direction of the sound reflected towards the average listener is calculated and the values of a digital filter emulated by a computer, designed to generate the impression of elevation of the reflected sound, are established.

4) Method as claimed in claim 1, characterised in that the behaviour of direct sound and reflected sounds is reconstructed separately.

5) Apparatus for the simulation of sounds in virtual positions in acoustic space, characterised in that it comprises:
a plurality of loudspeakers arranged in an area in which a listener is situated
means designed to drive and control each of the said loudspeakers independently of the others;
means designed to calculate the distance between the listener's position and the position of the source or area of Virtual reflection of the sound;
means designed to determine the direction of the line that joins the listener to the source or area of reflection of the sound;
means designed to select and drive a subset of loudspeakers to emit the sounds which make up the direct sound;
means designed to select a subset of loudspeakers to emit the sounds that make up the reflected sound;
means designed to calculate the amplitude components relating to the emission from the selected loudspeakers in such a way that the vector sum of the sounds emitted by the said selected loudspeakers is equivalent to the direct or reflected sound emitted by the virtual source.

6) Apparatus as claimed in the preceding claim, characterised in that it also includes means designed to calculate the angle of elevation of the source in relation to the listener and to establish the values of a digital filter designed to generate the impression of elevation of the sound.
